(19) United States
(12) Patent Application Publication
(10) Pub. No.: US 2005/0117233 A1
(43) Pub. Date: Jun. 2, 2005

(54) X-ray total reflection mirror and X-ray exposure apparatus

(75) Inventors: Hidehiro Kanazawa, Tokyo (JP); Kenji Ando, Utsunomiya-shi (JP); Kyoko Imai, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/990,493

(22) Filed: Nov. 18, 2004

(30) Foreign Application Priority Data
Nov. 21, 2003 (JP) 2003-391606

(51) Int. Cl. G02B 5/08; G02B 7/18; G02B 5/10

(52) U.S. Cl. 359/843

(57) ABSTRACT

Multilayer film structure composed of at least one pair of layers including a first layer and a second layer, which are formed from different materials, and a protective layer provided thereon is formed so that the structure is optimized to have the same theoretical reflectance as that of a single-layer film structure at the same incident angle θ. Since the absorption of each layer is not significant, the actual reflectance of the X-ray total reflection mirror having the multilayer film structure is closer to the theoretical value as compared to that of the X-ray total reflection mirror having the single-layer film structure.

### BACKGROUND OF THE INVENTION

1. Field of the Invention

The present invention relates to X-ray total reflection mirrors used, for example, for a projection optical system of an X-ray exposure apparatus and to X-ray exposure apparatuses.

2. Description of the Related Art

The refractive index of a substance becomes closer to one, as is the case under vacuum, when incident light is in the X-ray region, and some substances have a refractive index of less than one in the X-ray region. By using a substance with a refractive index of less than one, a so-called oblique incident total reflection mirror for light having a large incident angle has been used, for example, for a projection optical system of an X-ray exposure apparatus. However, in general, a substance has an absorption band in the X-ray region, and, hence, it has been difficult to obtain a high reflectance.

In addition, when a film having a thickness that is large enough for total reflection is formed from a single material, a columnar structure may be formed in some cases. Hence, the film surface thereof becomes irregular, resulting in a decrease in reflectance of the film. In particular, a total reflection film made of Mo, which is used in the EUV wavelength region, is susceptible to becoming crystallized to form large columnar grains, and, as a result, a decrease in reflectance may also occur.

Furthermore, compared to the density of a solid material, a film formed by a film formation method, such as sputtering or deposition, generally has a low density, and, since the refractive index of a film becomes closer to that of an environment in which the film is to be used when the density is low, the reflectance thereof tends to be further decreased. For example as shown in FIG. 4, in an X-ray total reflection mirror having a single-film structure composed of a Mo film 102 formed by sputtering on a substrate 101 and a silicon film 103 provided on the Mo film 102 as a protective layer, the actual reflectance is inevitably decreased as compared to the theoretical reflectance obtained by calculations based on the solid density.

Accordingly, in the total reflection region at a large incident angle, that is, in the case of oblique incidence, it has been difficult to realize an X-ray mirror having a sufficiently high reflectance.

On the contrary, in order to obtain a mirror having a high reflectance at a small incident angle in a region other than the total reflection region, a multilayer film structure is used. Japanese Patent Laid-Open No. 5-89818 discloses a widely known multilayer film that is similar to a laminate composed of layers having a ¼-wavelength thickness and that satisfies the Bragg reflection condition at vertical incidence.

### SUMMARY OF THE INVENTION

The present invention was made in consideration of the problems described above, which have not been solved by related techniques and an object of the present invention is to provide an X-ray total reflection mirror and an X-ray exposure apparatus using the same, the X-ray total reflection mirror realizing a higher reflectance than that of a single-layer X-ray total reflection mirror at an incident angle in the total reflection region.

To that end, in accordance with one aspect of the present invention, there is provided an X-ray total reflection mirror that is used for X-rays at an incident angle in the total reflection region, comprising a multilayer reflection film formed of at least one pair of layers composed of a first layer and a second layer, which have refractive indices different from each other. In the X-ray total reflection mirror described above, the multilayer reflection film is configured to have the same theoretical reflectance as that of an X-ray total reflection mirror having a single-layer structure at the same incident angle, the single-layer structure formed of the same material as that forming one of the first layer and the second layer.

One of the first layer and the second layer may comprise at least one material selected from the group consisting of Mo, Ru, and Rh, and the other layer may comprise at least one material selected from the group consisting of Si, Be, P, Sr, Rb, and RbC.

The first layer and the second layer may be formed by sputtering, deposition, or a similar technique.

The X-ray total reflection mirror described above, may further comprise a protective layer provided on the top of the multilayer reflection film, the protective layer comprising at least one material selected from the group consisting of C, Ru, Si, SiO₂, and B₄C.

In accordance with a second aspect of the present invention, there is provided an X-ray exposure apparatus comprising a projection optical system having the X-ray total reflection mirror described above.

In general, a film formed by a film formation method, such as sputtering or deposition, has a small density compared to that of a solid material. In the present invention, this apparently adverse phenomenon is positively exploited, that is, the decrease in density is used as benefit.

By the decrease in density of the film, the refractive index thereof becomes closer to that of an environment in which the film is to be used. Since an X-ray mirror is generally used under vacuum or under reduced pressure, the refractive index thereof becomes approximately one. Hence, in the case of an X-ray total reflection mirror having a single-layer structure composed of a single material, the actual reflectance is considerably decreased as compared to the theoretical value.

In addition, since the amount of absorption is also decreased as the density of the film is decreased, when the multilayer film structure is formed in combination with another material and is optimized at the same incident angle in the total reflection region as that for the single-layer structure, the actual reflectance becomes closer to the theoretical value as compared to that of the single-layer structure described above, and, as a result, an X-ray total reflection mirror having a high reflectance can be realized.

Further objects, features and advantages of the present invention will become apparent from the following description of the preferred embodiments with reference to the attached drawings.

### BRIEF DESCRIPTION OF THE DRAWINGS

FIG. 1A is a cross-sectional view showing a basic structure of an X-ray total reflection mirror made of a single-layer film for illustrating an embodiment of the present invention.

FIG. 1B is a cross-sectional view showing an X-ray total reflection mirror having a multilayer film structure obtained by optimization performed based on the basic structure shown in FIG. 1A.

FIG. 2 is a graph showing the relationship between the reflectance and the incident angle according to one example.

FIG. 3 is a graph showing the theoretical and actual reflectances of a single-layer structure with respect to the incident angle.

FIG. 4 is a cross-sectional view showing a film structure according to a related technique.

### DESCRIPTION OF THE PREFERRED EMBODIMENTS

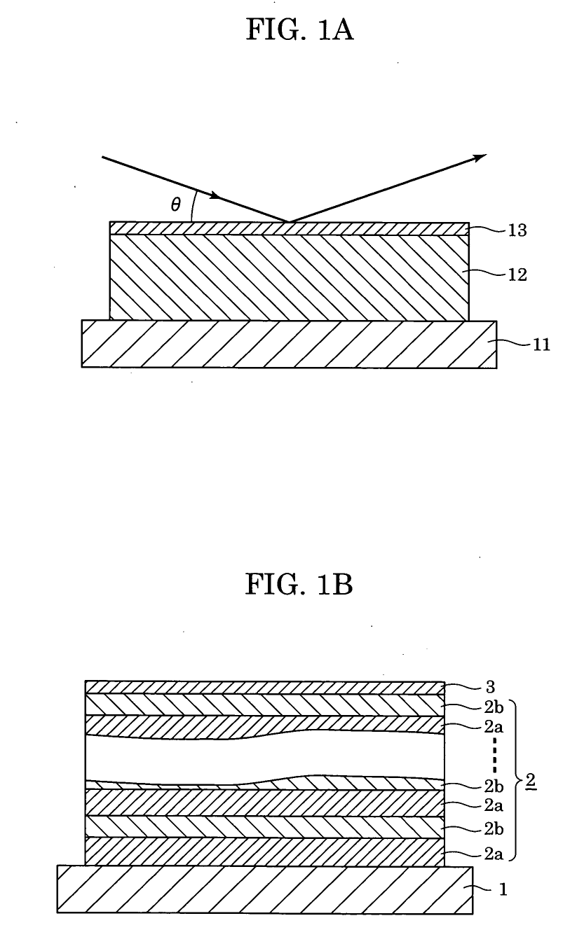

FIG. 1A shows an X-ray total reflection mirror having a single-layer structure which is composed of a single-layer reflection film 12 and a protective layer 13 provided in that order on a substrate 11, the X-ray total reflection mirror being used for oblique incidence of X-rays having an incident angle θ in the total reflection region. By using the same material used in the X-ray total reflection mirror having a single-layer structure, an X-ray total reflection mirror having a multilayer film structure is designed in which the same theoretical reflectance is obtained as that of the single-layer structure described above at the same oblique incidence angle θ. That is, in order to more closely achieve theoretical reflectance, the structure is optimized, as shown in FIG. 1B, by providing a multilayer film 2 having at least one pair of layers composed of a first layer 2a and a second layer 2b, which are layers of material having different refractive indices from each other, on a substrate 1, and on this multilayer film 2, a protective layer 3 is provided to complete the multilayer film structure.

A material for the single-layer reflection film 12, shown in FIG. 1A, and the material for the second layer 2b, shown in FIG. 1B, are the same material primarily composed of Mo, Ru, Rh, or a compound thereof. A material for the first layer 2a is primarily composed of Si, Be, P, Sr, Rb, RbC, or a compound thereof.

In addition, a material for the protective layer 3, which is provided on the top of the multilayer film 2 as an overcoat, for example, is primarily composed of C, Ru, Si, SiO₂, B₄C, or a compound thereof.

As methods for forming the first layer 2a, the second layer 2b, and the protective layer 3, for example, sputtering and deposition may be used.

When the X-ray total reflection mirror having a multilayer film structure shown in FIG. 1B is formed by sputtering or deposition, compared to the X-ray total reflection mirror having a single-layer structure shown in FIG. 1A, a high reflectance close to the theoretical value can be obtained. It is believed that, since the X-ray total reflection mirror having a multilayer film structure has less absorption, the reflectance thereof is close to the theoretical value obtained based on the solid density. Since the X-ray total reflection mirror having a single-layer structure has a low density, the change in refractive index because of the lower density has a considerable influence on the actual reflectance.

### [EXAMPLE]

The X-ray total reflection mirror having a multilayer film structure in this example was a mirror that was configured based on a basic structure of a total reflection mirror made of a Mo single-layer reflection film used at a wavelength of 13.5 nm in the X-ray region. As shown in FIG. 1B, a predetermined number of pairs, each composed of a first layer 2a of Si and a second layer 2b of Mo, were provided on a substrate 1 by sputtering, and on the top surface thereof, a protective layer 3 made of Si was provided as an overcoat. In this multilayer film structure, the thicknesses of the first Si layer, the second Mo layer, and the Si overcoat were 21±1 nm, 16±1 nm, and approximately 2 nm, respectively.

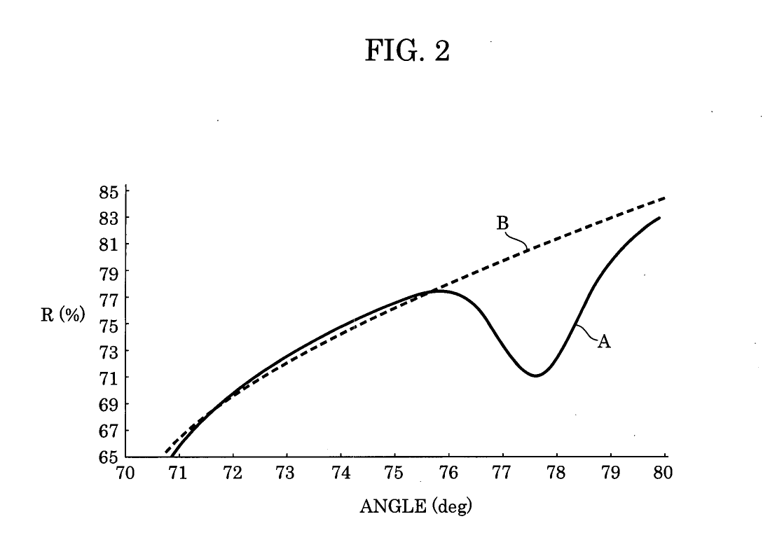

FIG. 2 is a graph showing the results obtained by the measurement of the incident angle (θ°) dependence of reflection characteristics of the X-ray total reflection mirror according to this example. In FIG. 2, a curve A indicated by a solid line shows an actual reflectance R of the multilayer film according to this example having a density of 97% of the solid density, and a curve B indicated by a dotted line shows an actual reflectance R of the Mo total reflection mirror, which was regarded as the base structure (single-layer structure), having a density of 97% of the solid density. As can be seen from FIG. 2, when the multilayer film structure is optimized at an incident angle of approximately 74°, a higher reflectance than that of the single-layer film, which is formed only from Mo, can be obtained.

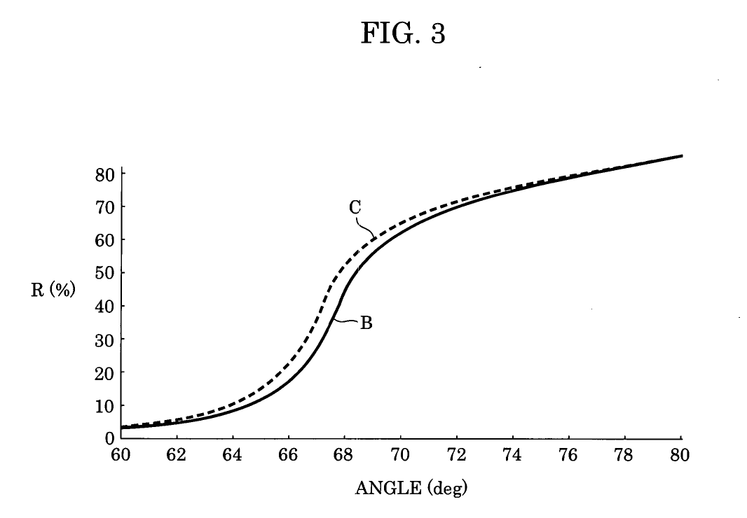

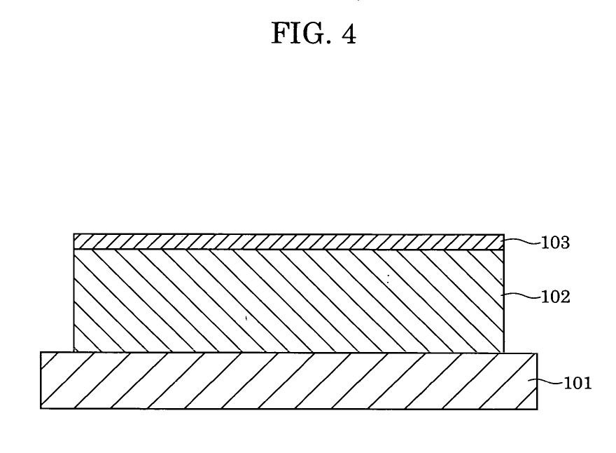

In FIG. 3, a curve B indicated by a solid line shows the incident angle dependence of the actual reflectance R of the Mo total reflection mirror having a single-layer structure, and a curve C indicated by a dotted line shows the theoretical reflectance obtained from the refractive index of the solid material. In the case where the total reflection mirror of a Mo single-layer film having a density of 97% of the solid density is formed by sputtering, it is understood that, due to the decrease in density of the film thus formed, the actual reflectance is decreased at an incident angle in the vicinity of the total reflection.

Incidentally, in the base structure described above, a single-layer reflection film 12 on a substrate 11 was a Mo film having a thickness of approximately 300 nm, and a protective layer 13 is a Si film having a thickness of approximately 2 nm.

As described above, even in the X-ray total reflection region at a large incident angle, a highly reflective mirror can be obtained when a multilayer film structure is formed, and when this highly reflective mirror is mounted on a projection optical system of an X-ray exposure apparatus, the performance thereof can be significantly improved.

Although the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2003-391606 filed Nov. 21st, 2003, which is incorporated herein by reference.

1. An X-ray total reflection mirror that is used for X-rays at an incident angle in the total reflection region, the X-ray total reflection mirror comprising:
a multilayer reflection film formed of at least one pair of layers composed of a first layer and a second layer, the first layer and the second layer having refractive indices different from each other,
wherein the multilayer reflection film is optimized to have the same theoretical reflectance as that of an X-ray total reflection mirror having a single-layer structure at the same incident angle, the single-layer structure formed of the same material as that forming one of the first layer and the second layer.

2. The X-ray total reflection mirror according to claim 1, wherein one of the first layer and the second layer comprises at least one material selected from the group consisting of Mo, Ru, and Rh, and the other layer comprises at least one material selected from the group consisting of Si, Be, P, Sr, Rb, and RbC.

3. The X-ray total reflection mirror according to claim 1, wherein the first layer and the second layer are formed by sputtering or deposition.

4. The X-ray total reflection mirror according to claim 1, further comprising a protective layer provided on the top of the multilayer reflection film, the protective layer comprising at least one material selected from the group consisting of C, Ru, Si, SiO₂, and B₄C.

5. An X-ray exposure apparatus comprising a projection optical system having the X-ray total reflection mirror according to claim 1.

6. The X-ray total reflection mirror according to claim 1, wherein the first layer consists of a Si layer with a thickness of approximately 21 nm, and the second layer consists of a Mo layer with a thickness of approximately 16 nm.

7. The X-ray total reflection mirror according to claim 1, further comprising a protective layer provided on the top of the multilayer reflection film with a thickness of approximately 2 nm.

8. An X-ray total reflection mirror comprising:
a substrate;
a multilayer film for reflecting X-rays; and
a protective layer,
wherein said multilayer film comprises:
at least one layer of a first material; and
at least one layer of a second material having a refractive index different from the layer of the first material.

9. The X-ray total reflection mirror according to claim 8, wherein the multilayer film is configured to have substantially the same theoretical reflectance, at a given oblique incident angle, as the X-ray total reflection mirror having a single-layer structure formed with one of the first material and the second material.

10. The X-ray total reflection mirror according to claim 8, wherein the layer of the first material and the layer of the second material are formed by sputtering or deposition.

11. The X-ray total reflection mirror according to claim 8, wherein one of the first material and the second material comprises at least one material selected from the group consisting of Mo, Ru, and Rh, and the other material comprises at least one material selected from the group consisting of Si, Be, P, Sr, Rb, and RbC.

12. The X-ray total reflection mirror according to claim 8, wherein the protective layer comprises at least one material selected from the group consisting of C, Ru, SiO₂, and B₄C.

13. The X-ray total reflection mirror according to claim 8, wherein the layer of the first material is a Si layer with a thickness of approximately 21 nm, the layer of the second material is a Mo layer with a thickness of approximately 16 nm, and the protective layer is a Si layer with a thickness of approximately 2 nm.

14. An X-ray exposure apparatus comprising a projection optical system having the X-ray total reflection mirror according to claim 8.

15. An X-ray total reflection mirror that is used for X-rays at an incident angle in the total reflection region, the X-ray total reflection mirror comprising:
a multilayer reflection film formed of at least one pair of layers composed of a first layer and a second layer, the first layer and the second layer having refractive indices different from each other,
wherein the multilayer reflection film is configured so as to have substantially the same theoretical reflectance value, at a given oblique incident angle, as an X-ray total reflection mirror having a single-layer structure formed of the same material as that used in one of the first layer and the second layer.
